(19) United States
(12) Patent Application Publication
(10) Pub. No.: US 2025/0156815 A1
(43) Pub. Date: May 15, 2025

(54) CONTENT GENERATOR WITH CUSTOMIZABLE INTERVIEW GENERATION, AUTOMATED MEDIA CAPTURE AND PROCESSING, AND DEMARCATED MEDIA GENERATION

(71) Applicant: David George Hall, Austin, TX (US)

(72) Inventor: David George Hall, Austin, TX (US)

(21) Appl. No.: 18/509,169

(22) Filed: Nov. 14, 2023

(51) Int. Cl. G06Q 10/1053; G06Q 50/00

(52) U.S. Cl. CPC G06Q 10/1053; G06Q 50/01

(57) ABSTRACT

A content generator with customizable interview generation, automated media capture and processing, and demarcated media generation is described. The content generator may allow a user to generate an interview by selecting from among various questions sets and/or generating new question sets. The question sets may be presented to one or more users and the responses captured (e.g., via audiovisual capture). The captured media may be analyzed and demarcated based on the associated questions (e.g., by demarcating each question and associated answer). The captured media may be analyzed to generate a written transcript. Sections of the written transcript may be associated with the sections of the demarcated media. The captured media, demarcated media, and/or written transcript (or sections thereof) may be stored to a file or otherwise made available for use or distribution via social media and/or web-based resources.

### BACKGROUND

Many users may wish to access subject-specific content and/or other content. Written content is difficult and time-consuming to generate.

Therefore, there exists a need for ways to create and distribute such content.

### BRIEF DESCRIPTION OF THE SEVERAL VIEWS OF THE DRAWING

The novel features of the disclosure are set forth in the appended claims. However, for purpose of explanation, several embodiments are illustrated in the following drawings.

FIG. 1 illustrates an example overview of one or more embodiments described herein, in which sets of questions are associated with an interview template;

FIG. 2 illustrates an example overview of one or more embodiments described herein, in which an interview is conducted and media is captured;

FIG. 3 illustrates an example overview of one or more embodiments described herein, in which captured interview media is processed;

FIG. 4 illustrates an example graphical user interface (GUI) of one or more embodiments described herein;

FIG. 5 illustrates a data structure diagram including various data elements that may be utilized by one or more embodiments described herein;

FIG. 6 illustrates a flow chart of an exemplary process that generates an interview template;

FIG. 7 illustrates a flow chart of an exemplary process that conducts an interview based on an interview template;

FIG. 8 illustrates a flow chart of an exemplary process that generates media based on an interview;

FIG. 9 illustrates a flow chart of an exemplary process that distributes interview media;

FIG. 10 illustrates a flow chart of an exemplary process that implements machine learning to optimize interview question sets; and

FIG. 11 illustrates a schematic block diagram of one or more exemplary devices used to implement various embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a content generator with customizable interview generation, automated media capture and processing, and demarcated media generation.

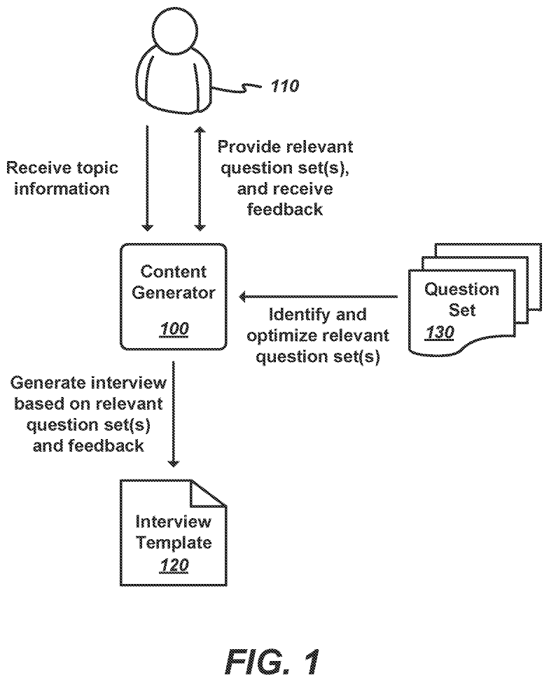

FIG. 1 illustrates an example overview of one or more embodiments described herein, in which content generator 100 receives topic information from a user 110 and allows the user 110 to generate an interview template (or interview “script”) 120 that may be used to conduct a set of video interviews and generate demarcated media as described below.

As shown, content generator 100 may receive topic information from user 110. Topic information may be received in various appropriate ways, such as indication of classifications via a user interface (UI) or graphical UI (GUI). Classifications may be indicated via a set of keywords, text entry, and/or other appropriate ways. Classifications may include various types, such as industry (e.g., entertainment, pet care, hospitality, finance, etc.), topic or subject (e.g., starting a business, producing a podcast, treating an illness, etc.), and/or other relevant and appropriate types. Classifications may be hierarchical. For example, an industry type such as “legal” may be associated with sub-types or sub-classifications such as “tax”, “probate”, “intellectual property”, etc. In some embodiments, classifications may be associated with one or more question sets 130 (e.g., via a lookup table or other mapping feature).

Content generator 100 may identify and/or optimize relevant question sets 130. Questions sets 130 may be identified by, for example, retrieving questions sets 130 associated with the various classifications and/or other topic information (e.g., via a lookup table or similar resource). Question sets 130 may be optimized via, for example, filtering based on classification and/or other topic information (e.g., a set of questions associated with the “legal” industry may be filtered based on the sub-type).

Content generator 100 may provide the relevant question sets 130 (or elements thereof) to user 110 (e.g., via a GUI of some embodiments) and receive feedback (e.g., via a GUI of some embodiments), if any. Feedback may include collection of additional classification information, modifications to existing questions, removal of questions, addition of custom questions, organization of questions (e.g., order, grouping, etc.), and/or other appropriate feedback. Feedback may include assignment of questions (or sets of questions) to an interviewee-user 110 (or interview subject).

Content generator 100 may generate an interview based on the relevant question sets 130 and/or any feedback. The interview may be stored as an interview template 120 that may include a listing of questions to be included in the interview, an interviewee-user 110 associated with each question (or sets of questions) and/or other question attributes (e.g., order or rank, time limit, etc.).

Content generator 100 may be, include, and/or utilize a set of electronic components, set of devices, and/or set of systems that may be able to execute instructions and/or otherwise process data. Content generator 100 may be able to interact with various entities (e.g., users 110) via resources such as UIs, network connections, apps or other software, and/or other communication pathways.

User or other entity 110 may be a person, such as an interviewee, interview manager or administrator, question source, server, storage, and/or other appropriate entity.

Interview template 120 may be a file or other resource that may indicate information related to the interview, such as included question sets 130 (and/or elements thereof), order of elements, grouping of elements (e.g., questions associated with a particular interviewee-user 110), associated interviewee-user 110, and/or other relevant information.

Each question set 130 may include a listing of questions, associated filtering and/or other criteria, associated classification information, and/or other relevant information such as a source of each question, statistics or other performance metrics (e.g., selection probability based on received classification information, user feedback regarding question relevance or helpfulness, etc.). Questions sets 310 may include default questions and/or sets of questions that may be appropriate for many or all classifications or cases where no matching classifications are identified.

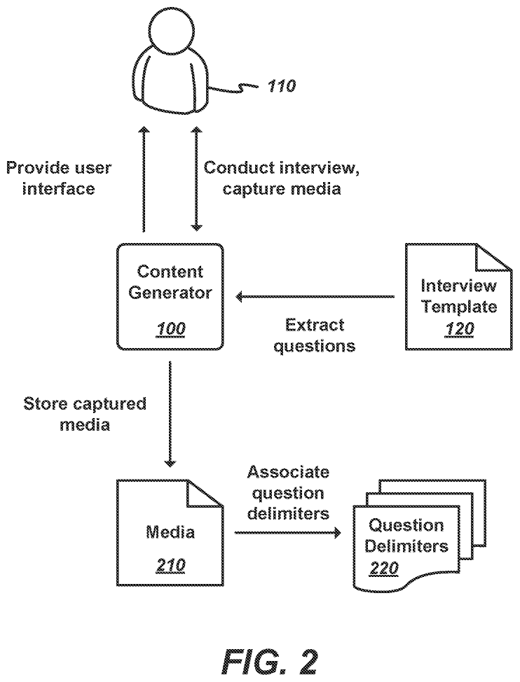

FIG. 2 illustrates an example overview of one or more embodiments described herein, in which an interview is conducted and media is captured. Interviews may be conducted using audio, audiovisual, and/or text-based presentation of questions and audio, audiovisual, and/or text-based capture of responses. Each interview may be conducted using various appropriate devices (e.g., smartphones, personal computers, tablets, etc.) and/or components thereof or other associated components (e.g., displays, cameras, speakers, microphones, keyboards, etc.).

As shown, content generator 100 may extract questions and/or other information (e.g., interviewee-user 110 information) from the interview template 120. Content generator 100 may identify the current or next question from the interview template 120 and provide a UI or GUI to the associated interviewee-user 110.

Content generator 100 may conduct the interview and/or capture media via the UI or GUI of some embodiments. Each question may be presented to the associated interviewee-user 110 and the response may be captured. For example, the next question may be provided as a text-based and/or audio prompt. In some cases, the question may include associated media (e.g., audio or audiovisual content) that may be generated by one or more interviewer-users 110 or an automated resource. Likewise, each response may be captured as text, audio, audiovisual, and/or other appropriate types of content.

During the interview, questions may be delimited in various appropriate ways. For instance, in some cases each question may have a designated response time, where a response is captured for the designated amount of time before proceeding to the next question. As another example, the response may be analyzed to determine when the response is complete (e.g., when a user 110 stops talking for more than a specified threshold length of time), when an “enter” command is received via a keyboard, and/or under other appropriate conditions. As another example, the UI or

GUI of some embodiments may receive an indication that the response is complete from the user 110 (e.g., by receiving a “button press” associated with a “next question” GUI feature).

Content generator 100 may store the captured media 210 to a storage associated with content generator 100 (e.g., to a file and/or other appropriate resource). Typically, the media 210 may include audiovisual content including the responses to the questions. In some cases, the questions may also be included with the media 210. Content generator 100 may associated question delimiters 220 to media 210. Question delimiters 220 may include, for instance, edit points for audiovisual media (e.g., start time and end time, start time and duration, etc.). Question delimiters 220 may be used to define sections of media 210 that include (or are otherwise associated with) one or more interview questions and the associated answer(s). Media 210 may include and/or be associated with metadata and/or similar content (e.g., indicating classification type(s), user identity, etc.).

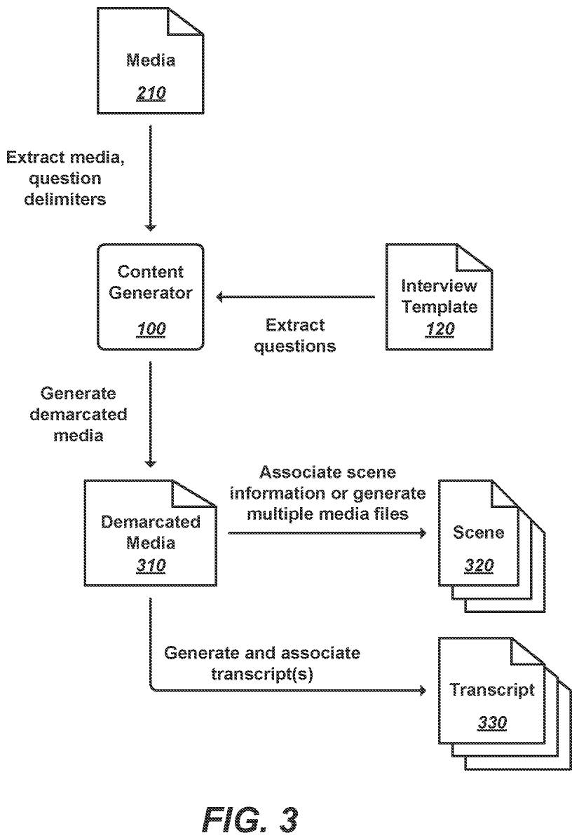

FIG. 3 illustrates an example overview of one or more embodiments described herein, in which captured interview media 210 is processed for distribution. Media 210 may be received from a storage associated with content generator 100. Content generator 100 may extract the media content, question delimiters 220, metadata, and/or other information associated with media 210.

Media 210 may include a reference to the interview template 120 and/or may include a copy of the interview template 120. Content generator 100 may extract the interview questions and/or other relevant information from the interview template 120 (e.g., topic(s), classification(s), associated users 110, etc.). In some cases, content generator 100 may analyze the media 210 to determine attributes such as question delimiters 220 (e.g., by identifying pauses or other indications that an answer is complete).

Content generator 100 may use the question delimiters 220, extracted interview questions, and/or other appropriate information to generate demarcated media 310. Demarcated media 310 may be associated with scenes 320 (and/or other types of sections or section indicators) and/or divided into multiple files (where the term “scenes” may be used herein to refer to separate media files or scene information associated with a media file). Each scene 320 or media file may include, or otherwise be associated with, one or more questions and associated answer(s). Each scene 320 may include an introduction and closing section (and/or transition content), media content associated with the question(s) and answer(s), and/or other relevant information, where such elements may be selected and/or generated based on attributes or classifications such as topic(s), industry, etc. Such introduction and closing sections may include automatically generated information, such as timestamps or dates, contributors, disclaimers, etc.

Content generator 100 may generate one or more transcripts 330 that may be associated with demarcated media 310 and/or scenes 320. Each transcript 330 may include elements such as searchable text, hyperlinks or other references to external resources (e.g., websites associated with a user 110, topic(s), etc.). A transcript 330 may be divided into sections, such that each section is associated with a different scene 320.

The demarcated media 310, scenes 320, and/or transcripts 330 may be distributed to various users 110 across various different platforms. For instance, scenes 320 may be embedded on a website. As another example, media files associated with demarcated media 310, scenes 320, and/or transcripts 330 may be shared across social media sites. As still another example, media files associated with demarcated media 310, scenes 320, and/or transcripts 330 may be pushed or otherwise sent to sets of designated users or other parties or entities.

In some embodiments, media content, editing information, and/or other data may be received from user 110 and/or other appropriate entities to generate the demarcated media 310. For example, separate scenes 320 may be combined into a single scene (e.g., multiple questions may be combined into a single scene when appropriate). As another example, multiple answers may be combined to a single answer and intervening questions may be removed or combined together into a single question. As still another example, content such as graphics (e.g., a company logo, a profile picture for a user 110, etc.), text (e.g., disclaimers, company information, etc.), and/or other content may be associated with demarcated media 310 (e.g., by overlaying text, by adding graphical content to one or more frames of video, etc.).

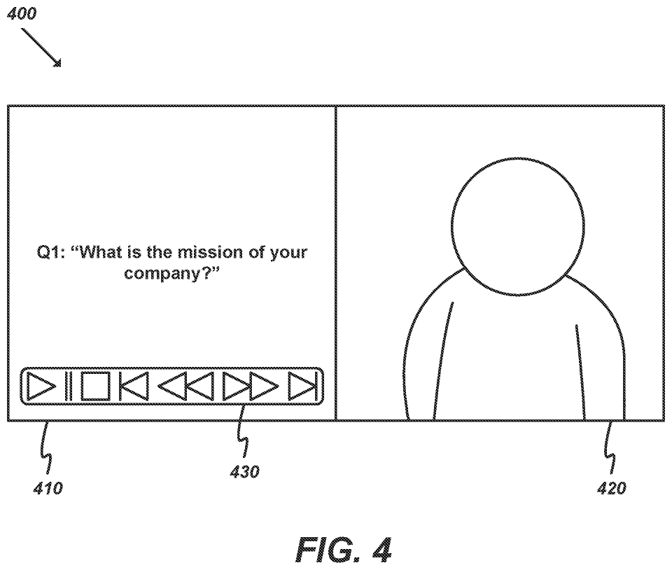

FIG. 4 illustrates an example GUI 400 of one or more embodiments described herein. Different embodiments may provide various different GUIs and/or GUI elements than shown. For example, the GUI attributes may vary depending on attributes such as screen size, orientation, etc. As another example, GUI attributes may vary depending on platform (e.g., a web-based portal, an application installed on a user device, etc.). As still another example, GUI attributes may be user customizable. Any number of different GUIs may be provided for different use cases. For instance, a first GUI may be associated with selection of interview questions and/or other aspects of interview generation. A second GUI (e.g., GUI 400) may be associated with conducting an interview. A third GUI may be associated with media editing and/or distribution of media. This simplified example GUI 400 includes a question presentation section 410, a media capture section 420, and playback controls 430.

Question presentation section 410 in this example includes a text-based display that provides the current question. The question presentation section 410 may include various informational elements, such as question number, total number of questions, elapsed time, user information, and/or other relevant information. GUI 400 may provide questions via other features, such as an audio output, an audiovisual output, and/or other appropriate elements.

Media capture section 420 may include a display window as shown that may provide video content of the interviewee-user 110. In some embodiments, other types of media may be captured and/or received. For instance, graphs or charts, images, and/or other data may be uploaded from a user 110 and/or received from an external resource such as a server or application programming interface (API).

Playback controls 430 may include various appropriate controls such as start, stop, pause, next question (or other type of section), previous question (or other type of section), etc. Playback controls 430 may allow a user 110 to at least partially define question delimiters 220 (e.g., when a “next question” command is received via a resource such as playback controls 430, an endpoint and a start point may be defined within the associated media content).

GUI 400 and/or other associated GUIs may include elements such as editing tools, file resources, other types of displays, selection elements (e.g., question selection elements), and/or various other appropriate elements that may be used to perform various operations described herein.

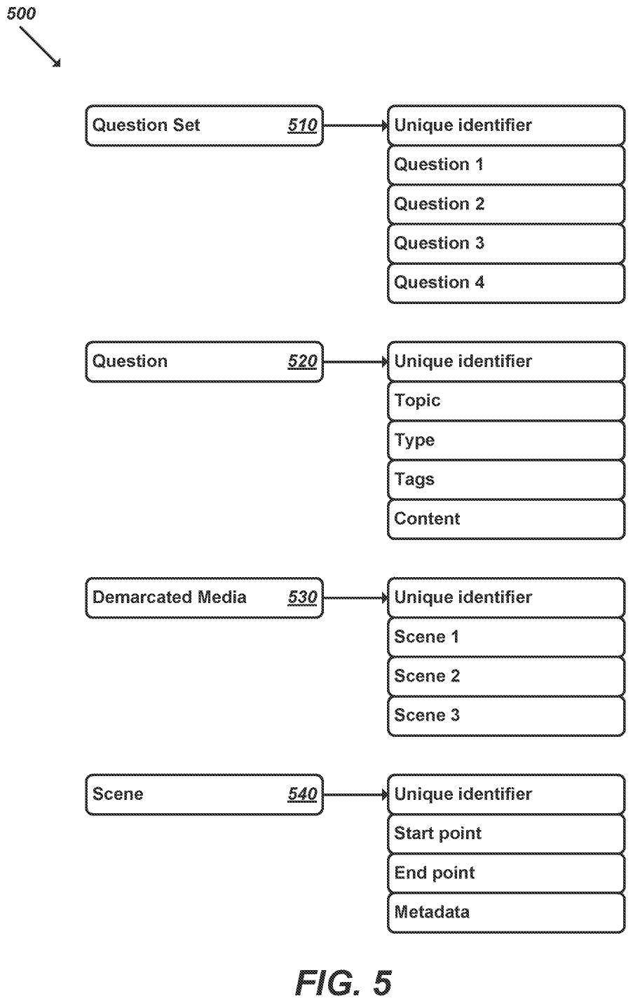

FIG. 5 illustrates a data structure diagram 500 including various data elements that may be utilized by one or more embodiments described herein. As shown, data structure diagram 500 includes a question set element 510, question element 520, demarcated media element 530, and scene element 540. Each element may be instantiated any number of times.

Question set element 510 may include a unique identifier (e.g., a serial number) and references to associated questions (e.g., a listing of question element 520 identifiers). Question set element 510 may include other components such as associated classification(s), source (e.g., a username of an author, a website or similar resource, etc.), and/or other relevant information.

Question element 520 may include a unique identifier (e.g., a serial number), topic information, type information, tags and/or other metadata, and question content (e.g., a text-based representation of the question content). Question element 520 may include various other components such as references to suggested interviewee-users 110, demarcation indicators and/or criteria, and/or other relevant information.

Demarcated media element 530 may include a unique identifier (e.g., a serial number) and references to associated scenes (e.g., a listing of scene element 540 identifiers). Demarcated media element 530 may include other components such as captured media and/or other media (or references thereto), metadata, and/or other relevant information.

Scene element 540 may include a unique identifier (e.g., a serial number), a start point, an end point, and associated metadata. Scene element 540 may include other components such as captured media and/or other media (or references thereto), associated transitions, introductions, and/or closing sections, and/or other relevant information.

One of ordinary skill in the art will recognize that different embodiments may include various different types of data elements having various different components. For instance, in some embodiments, the demarcated media element 530 and/or scene element 540 may include media content. As another example, some embodiments may include a “transcript” data element that stores transcript information such as searchable text, a unique transcript identifier, a reference to associated media content, a reference to associated question(s), etc. As another example, a “user” data element may include a username, password, profile information (e.g., email address), and/or other appropriate components (e.g., UI preferences, area(s) of expertise, etc.).

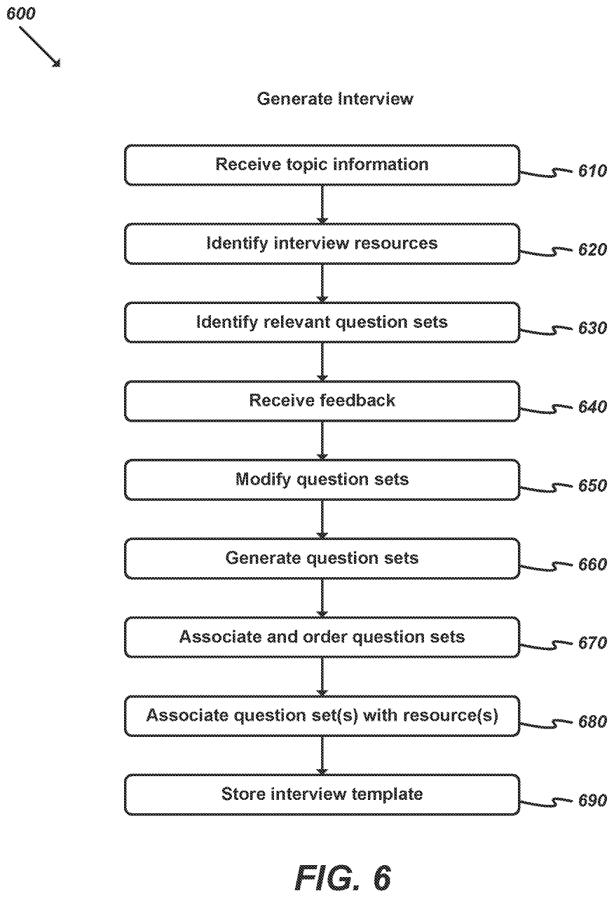

FIG. 6 illustrates an example process 600 for generating an interview template such as interview template 120. Such a process may allow a user 110 to generate the interview template 120 using various GUIs or similar features to select a set of questions. In some embodiments, the process 600 may automatically generate an interview template (e.g., based on some classification information or a default selection). The process 600 may be performed when a new interview is generated. In some embodiments, process 600 may be performed by content generator 100.

As shown, process 600 may include receiving (at 610) topic information. Topic information may be received in various appropriate ways. For instance, a GUI of some embodiments may allow a user 110 to select from various available classifications or to generate new classifications.

Process 600 may include identifying (at 620) interview resources. Interview resources may be identified in various appropriate ways. For example, a roster of interviewee-users 110 may include associated topics that are appropriate for each resource and interview resources may be suggested by the content generator 100. As another example, a user 110 may designate an interview resource for each question or set of questions.

The process 600 may include identifying (at 630) one or more relevant question sets. Based on the topic information and/or other relevant criteria, potentially relevant question sets 130 may be identified. In some cases, one or more default question sets 130 may be selected independent of the topic information. Questions sets 130 may be generated by various users 110 or other entities and shared with other users 110 or entities. For example, question sets 130 previously created by other users 110 (or portions thereof) may be shared with a user 110 based on similarity of topic information.

As shown, process 600 may include receiving (at 640) feedback. Feedback may be received via a GUI or other appropriate element. Such feedback may include, for instance, selection of some questions from a question set 130, creation of new questions or question sets 130, removal of questions from a question set 130, combination of question sets 130, division of question sets 130, etc. Other types of editing, such as question order, associated interviewee-user 110, etc. may be included in such feedback.

Process 600 may include modifying (at 650) the question set(s) 130 based on the feedback. Question sets 130 may be modified by adding questions, removing questions, changing the order of questions, associating questions, disassociating questions, etc.

The process 600 may include generating (at 660) question sets 130. New question sets 130 may be generated based on newly received questions, new combinations of existing questions, association of existing questions to new topics or classifications, and/or based on other relevant criteria.

As shown, process 600 may include associating and ordering (at 670) the question sets 130. The question sets 130 and associated information (or references thereto) may be added to a listing or similar data structure that may indicate the associated question sets 130 and ordering thereof (or sub-ordering of questions within each question set 130).

Process 600 may include associating (at 680) question sets 130 (or portions thereof) with resources. Each question set 130 (or portion thereof) may be associated with an interviewee-user 110. In some cases, a default user may be associated (e.g., the interview creator may be associated with each question set 130 unless another entity is designated).

The process 600 may include storing (at 690) an interview template 120. The interview template 120 may be a file or other data structures that includes the question sets 130 (or references thereto), listings of associated users (or references thereto), topic information, and/or other relevant information.

Different embodiments may allow various different types of editing operations when generating an interview. For instance, a user 110 may be able to select from various templates, skins, styles, etc., depending on the desired look of the interview. As another example, a user 110 may be able to select from different formatting for the interview presentation (e.g., text size, font, etc.).

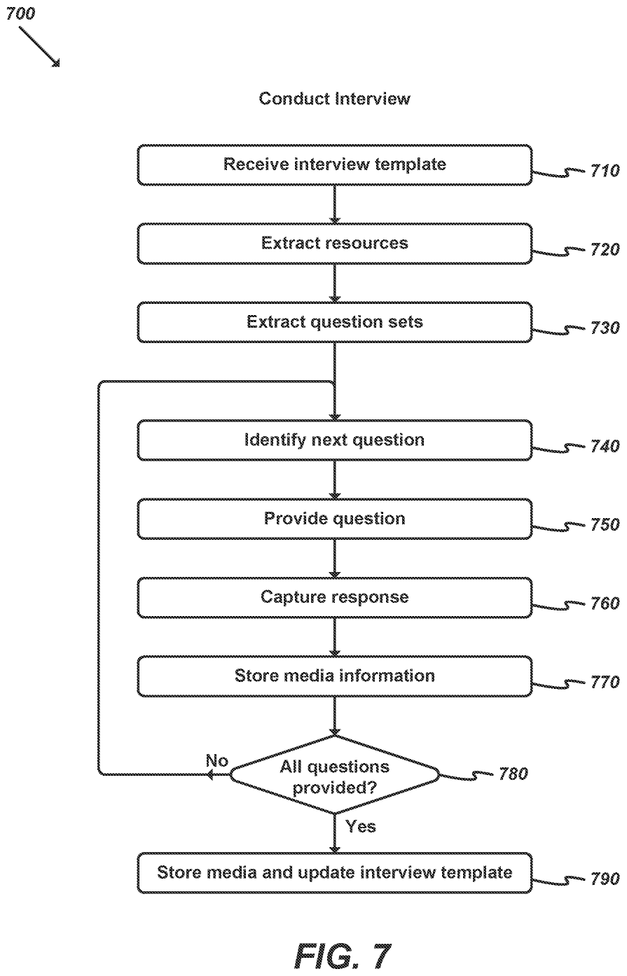

FIG. 7 illustrates an example process 700 for conducting an interview based on an interview template. The process 700 may provide interview questions and capture media associated with responses to the questions. The process 700 may be performed when an interview (or portion thereof) is conducted and media is captured. In some embodiments, process 700 may be performed by content generator 100.

As shown, process 700 may include receiving (at 710) an interview template 120. The interview template 120 may be received from a storage, server, or other appropriate resource, based on a unique interview template identifier or other reference. A single interview template 120 may be used by various users 110 to conduct any number of interviews.

Process 700 may include extracting (at 720) associated resources. Resources such as interviewee-users 110, associated content, and/or associated resources may be extracted from the interview template 120.

The process 700 may include extracting (at 730) question sets 130. The questions sets 130 may be extracted from the interview template 120 and/or received based on unique question set identifiers included in the interview template 120. The extracted questions sets 130 may be stored to an ordered list or similar resource.

As shown, process 700 may include identifying (at 740) a next question. The next question may be received from a resource such as the ordered list of question sets 130 (or questions).

Process 700 may include providing (at 750) the next question. The next or current question may be provided via a resource such as the question presentation section 410 of GUI 400 and/or via various hardware resources such as a display, speakers, etc. The question may be provided via text, audio, audiovisual media, graphics, etc.

The process 700 may include capturing (at 760) a response. Typically, an audiovisual response may be captured via resources such as a microphone and video camera. Other types of responses may be captured (e.g., text-based responses).

As shown, process 700 may include storing (at 770) media information. The captured media may be stored to a file or similar resource. Associated information may also be stored or references, such as start time of question presentation, end time of response, etc.

Process 700 may include determining (at 780) whether all questions have been provided. Such a determination may be made, for example, by examining the listing of question sets 130 to determine if a next question is available. If the process 700 determines (at 780) that all questions have not been provided, the process 700 may repeat operations 740-780 until the process 700 determines (at 780) that all questions have been provided.

If the process 700 determines (at 780) that all questions have been provided, the process 700 may include storing (at 790) the interview media and updating (at 790) the interview template 120 if needed. The interview media may be stored to a file or other appropriate data structure. The interview template 120 may be updated or modified based on the interview presentation and/or responses thereto. For example, if a question is skipped (i.e., no answer is provided), the question may be removed from the question set 130 and interview template 120.

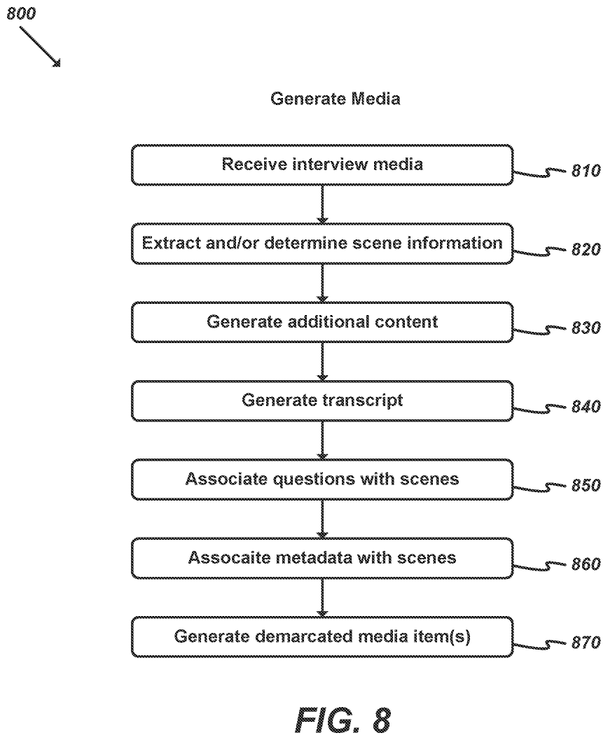

FIG. 8 illustrates an example process 800 for generating media based on an interview. The process 800 may be performed when an interview has been conducted or interview media (or some portion thereof) otherwise becomes available. In some embodiments, process 800 may be performed by content generator 100.

As shown, process 800 may include receiving (at 810) interview media. The captured interview media may be received from a storage or other appropriate resource. Similarly, the associated interview template 120 may be received.

Process 800 may include extracting and/or determining (at 820) scene information. Scene information may be determined in various appropriate ways. For instance, captured media may be automatically analyzed to determine whether pauses or other indicators of demarcation have occurred.

As another example, user inputs (e.g., a “next question” selection) may be used to identify demarcation points. As another example, demarcation points such as a question start may be automatically stored when the media is presented to an interviewee.

The process 800 may include generating (at 830) additional content. Such additional content may include, for instance, introductions, closing sections, transitions, etc. Such content may be selected or generated based on information such as selected classification(s). Other additional content may include, for example, graphics or data tables that may be embedded with captured content. For instance, a chart or graph may replace video media for a period of time. As another example, a data or graphics overlay may be generated and rendered onto the video media.

As shown, process 800 may include generating (at 840) a transcript. Captured audio may be analyzed to generate a transcript. The transcript may be modified based on user feedback. Elements of the transcript may be automatically linked to various sources or other resources (e.g., if a universal resource locator (URL) is captured via audio content, a clickable link or similar element may be generated and associated with the transcript).

Process 800 may include associating (at 850) questions with scenes. Each question may be associated with a data element, such as question element 520 that may include elements such as classifications, metadata, etc. The question information (or references thereto) may be associated with sections of captured media, such as the scene information extracted (at 820).

The process 800 may include associating (at 860) metadata with scenes. Metadata may include, for instance, interviewee information, topic information, classification information, associated links or other resources, and/or any other relevant information that may be associated with the captured media content.

As shown, process 800 may include generating (at 870) a set of demarcated media items. One or more demarcated media items, such as demarcated media 310, scenes 320, and/or transcripts 330 may be generated and associated to each other. The demarcated media items may be stored to a storage or other resource associated with content generator 100.

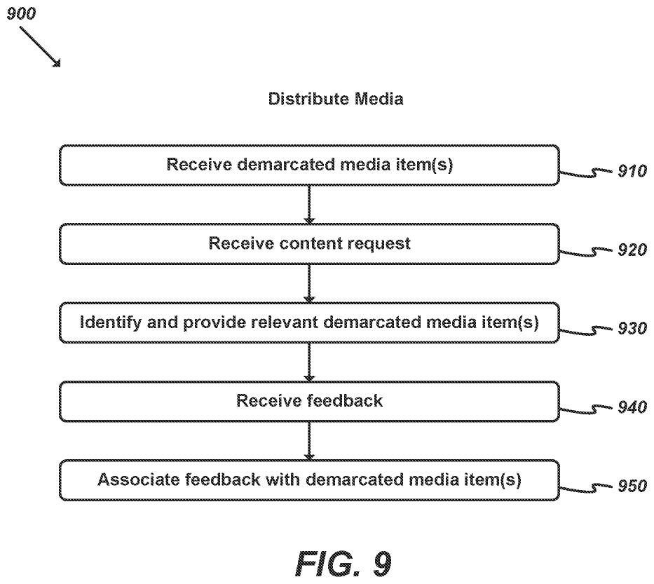

FIG. 9 illustrates an example process 900 for distributing interview media. The demarcated media items may be distributed across various appropriate platforms (e.g., a website, social media platform, etc.) or via various appropriate resources (e.g., a media server). The process 900 may be performed when demarcated media is generated or otherwise made available for distribution. In some embodiments, process 900 may be performed by content generator 100.

As shown, process 900 may include receiving (at 910) demarcated media items. Demarcated media items may be received from a storage or other appropriate resource associated with content generator 100. All available demarcated media items may be included in a single listing such as a lookup table, such that relevant media items may be identified based on topic, classification, user information, etc.

Process 900 may include receiving (at 920) a content request. Such a content request may be received by content generator 100 via various appropriate channels. For instance, a user 110 may click a link or similar reference at a website. As another example, a user 110 may search a social media platform of some embodiments for relevant information related to a topic or classification.

The process 900 may include identifying and providing (at 930) relevant demarcated media items. Based on the received request (and/or criteria provided therein), relevant demarcated media items may be identified (e.g., by matching or filtering listed items based on classifications or other criteria provided with the content request). The relevant demarcated media items may be provided via a listing or other appropriate resource (e.g., a media playlist).

As shown, process 900 may include receiving (at 940) feedback. Feedback may include feedback related to various aspects of the media selection and presentation. For instance, if a user 110 watches an entire scene based on a content request, positive feedback may be imputed, whereas if a user does not complete a scene before leaving or proceeding to a next scene, negative feedback may be imputed. As another example, a user 110 may indicate the relevance of one or more matching media items. As still another example, a user 110 may indicate whether information provided via the scene was helpful or useful.

Process 900 may include associating (at 950) feedback with demarcated media items (and associated question sets, classifications, topics, etc.). Such feedback may be associated in various different ways. For example, a rating or similar metric may be generated and/or updated based on received feedback and the rating or similar metric may be stored as metadata associated with a demarcated media item.

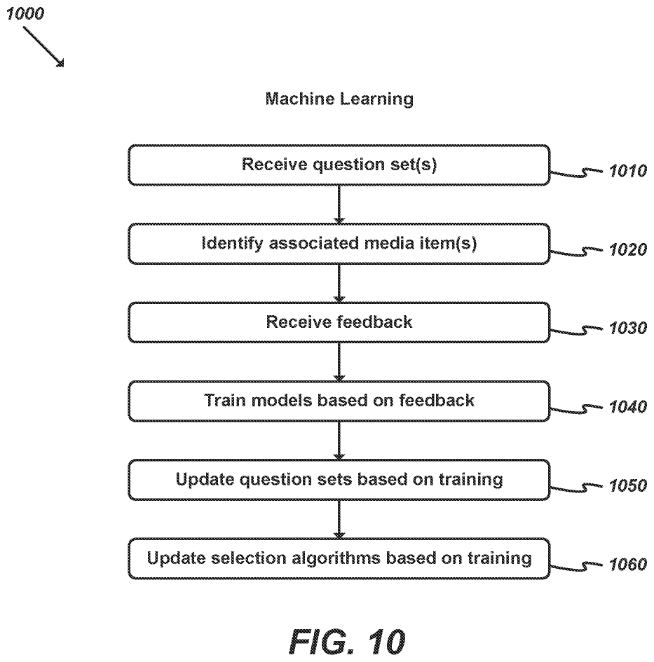

FIG. 10 illustrates an example process 1000 for implementing machine learning to optimize interview question sets. Machine learning may be applied to various elements associated with content generation and distribution. For example, question sets 130 may be selected or recommended based on machine learning models. As another example, demarcated media items may be selected or recommended based on machine learning models. The process 1000 may be performed when training data is received or otherwise made available. In some embodiments, process 1000 may be performed by content generator 100.

As shown, process 1000 may include receiving (at 1010) one or more question sets 130. Question sets 130 may be received from a storage associated with content generator 100.

Process 1000 may include identifying (at 1020) associated media items, such as demarcated media items. Such media items may be identified by extracting associated question set identifiers and determining which media items reference such question set identifiers.

The process 1000 may include receiving (at 1030) feedback. Feedback and/or other training data may be received from various appropriate resources, such as a storage associated with content generator 100. Feedback may be associated with various types of operations (e.g., question set selection or modification, selection or viewing of demarcated media items, ratings of demarcated media items, etc.).

As shown, process 1000 may include training (at 1040) models based on the feedback. The machine learning models may be trained using various appropriate algorithms.

Process 1000 may include updating (at 1050) question sets 130 based on the training. Question sets 130 may be updated in various appropriate ways. For instance, questions may be added to and/or removed from a question set 130. As another example, the order of questions in a question set 130 may be modified. As still another example, classifications associated with a question set 130 may be added, removed, or otherwise modified.

The process 1000 may include updating (at 1060) selection algorithms based on the training. Selection algorithms may be used to recommend question sets based on provided classification information and/or other relevant information. Thus, for example, if a first question set 130 is selected more often than a second question set 130, the first question set 130 may be more likely to be recommended in the future based on similar selection criteria and the second question set 130 may be less likely to be recommended.

Although process 1000 was described with reference to question content and selection, one of ordinary skill in the art will recognize that similar processes may be used for other aspects of content generation. For example, machine learning models may be trained to identify question delimiters 220. As another example, machine learning models may be trained to improve transcript accuracy and/or relevance of associated resources.

One of ordinary skill in the art will recognize that processes 600-1000 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

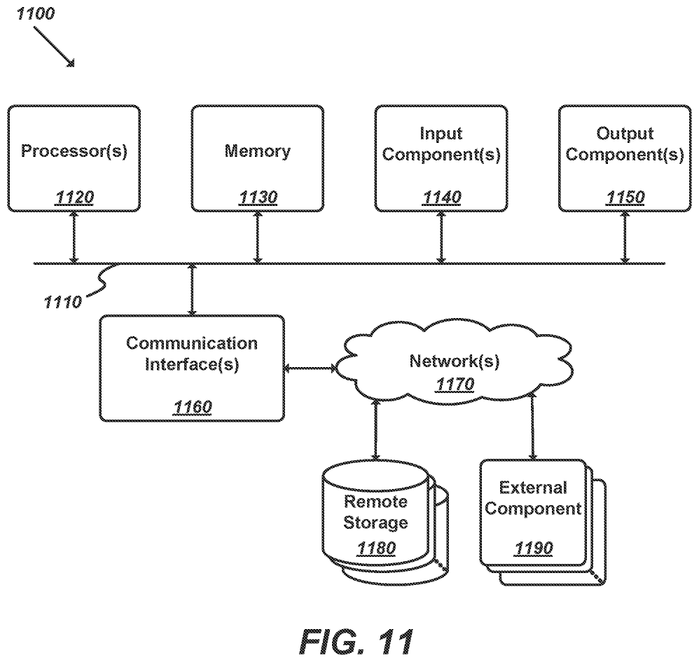

FIG. 11 illustrates a schematic block diagram of an exemplary device (or system or devices) 1100 used to implement some embodiments. For example, the systems, devices, components, and/or operations described above in reference to FIG. 1, FIG. 2, FIG. 3, FIG. 4, and FIG. 5 may be at least partially implemented using device 1100. As another example, the processes described in reference to FIG. 6, FIG. 7, FIG. 8, FIG. 9, and FIG. 10 may be at least partially implemented using device 1100.

Device 1100 may be implemented using various appropriate elements and/or sub-devices. For instance, device 1100 may be implemented using one or more personal computers (PCs), servers, mobile devices (e.g., smartphones), tablet devices, wearable devices, and/or any other appropriate devices. The various devices may work alone (e.g., device 1100 may be implemented as a single smartphone) or in conjunction (e.g., some components of the device 1100 may be provided by a mobile device while other components are provided by a server).

As shown, device 1100 may include at least one communication bus 1110, one or more processors 1120, memory 1130, input components 1140, output components 1150, and one or more communication interfaces 1160.

Bus 1110 may include various communication pathways that allow communication among the components of device 1100. Processor 1120 may include a processor, microprocessor, microcontroller, DSP, logic circuitry, and/or other appropriate processing components that may be able to interpret and execute instructions and/or otherwise manipulate data. Memory 1130 may include dynamic and/or non-volatile memory structures and/or devices that may store data and/or instructions for use by other components of device 1100. Such a memory device 1130 may include space within a single physical memory device or spread across multiple physical memory devices.

Input components 1140 may include elements that allow a user to communicate information to the computer system and/or manipulate various operations of the system. The input components may include keyboards, cursor control devices, audio input devices and/or video input devices, touchscreens, motion sensors, etc. Output components 1150 may include displays, touchscreens, audio elements such as speakers, indicators such as light-emitting diodes (LEDs), printers, haptic or other sensory elements, etc. Some or all of the input and/or output components may be wirelessly or optically connected to the device 1100.

Device 1100 may include one or more communication interfaces 1160 that are able to connect to one or more networks 1170 or other communication pathways. For example, device 1100 may be coupled to a web server on the Internet such that a web browser executing on device 1100 may interact with the web server as a user interacts with an interface that operates in the web browser. Device 1100 may be able to access one or more remote storages 1180 and one or more external components 1190 through the communication interface 1160 and network 1170. The communication interface(s) 1160 may include one or more APIs that may allow the device 1100 to access remote systems and/or storages and also may allow remote systems and/or storages to access device 1100 (or elements thereof).

It should be recognized by one of ordinary skill in the art that any or all of the components of computer system 1100 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1100 may perform various operations in response to processor 1120 executing software instructions stored in a computer-readable medium, such as memory 1130. Such operations may include manipulations of the output components 1150 (e.g., display of information, haptic feedback, audio outputs, etc.), communication interface 1160 (e.g., establishing a communication channel with another device or component, sending and/or receiving sets of messages, etc.), and/or other components of device 1100.

The software instructions may be read into memory 1130 from another computer-readable medium or from another device. The software instructions stored in memory 1130 may cause processor 1120 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

I claim:

1. A device, comprising:
one or more processors configured to:
receive topic information associated with a topic;
identify at least one relevant question set based on the topic information, wherein the at least one relevant question set comprises a set of questions;
generate an interview template based on the at least one relevant question set; and
conduct an interview based on the interview template, wherein conducting the interview comprises capturing media content of an interview subject.

2. The device of claim 1, the one or more processors further configured to generate a plurality of demarcated media items, wherein each demarcated media item from the plurality of demarcated media items is associated with a particular question from the set of questions.

3. The device of claim 2, wherein each demarcated media item from the plurality of demarcated media items comprises a start time and an end time associated with the captured media content of the interview subject.

4. The device of claim 3, the one or more processors further configured to generate a transcript of the interview by analyzing the captured media content of the interview subject.

5. The device of claim 4, the one or more processors further configured to divide the transcript into sections, wherein each section is associated with a different demarcated media item from the plurality of demarcated media items.

6. The device of claim 5, wherein the start time and the end time are determined based on user selections made while the interview is conducted.

7. The device of claim 1, wherein the topic information comprises a set of classifications.

8. A non-transitory computer-readable medium, storing a plurality of processor-executable instructions to:
receive topic information associated with a topic;
identify at least one relevant question set based on the topic information, wherein the at least one relevant question set comprises a set of questions;
generate an interview template based on the at least one relevant question set; and
conduct an interview based on the interview template, wherein conducting the interview comprises capturing media content of an interview subject.

9. The non-transitory computer-readable medium of claim 8, the plurality of processor-executable instructions further to generate a plurality of demarcated media items, wherein each demarcated media item from the plurality of demarcated media items is associated with a particular question from the set of questions.

10. The non-transitory computer-readable medium of claim 9, wherein each demarcated media item from the plurality of demarcated media items comprises a start time and an end time associated with the captured media content of the interview subject.

11. The non-transitory computer-readable medium of claim 10, the plurality of processor-executable instructions further to generate a transcript of the interview by analyzing the captured media content of the interview subject.

12. The non-transitory computer-readable medium of claim 11, the plurality of processor-executable instructions further to divide the transcript into sections, wherein each section is associated with a different demarcated media item from the plurality of demarcated media items.

13. The non-transitory computer-readable medium of claim 12, wherein the start time and the end time are determined based on user selections made while the interview is conducted.

14. The non-transitory computer-readable medium of claim 8, wherein the topic information comprises a set of classifications.

15. A method comprising:
receiving topic information associated with a topic;
identifying at least one relevant question set based on the topic information, wherein the at least one relevant question set comprises a set of questions;
generating an interview template based on the at least one relevant question set; and
conducting an interview based on the interview template, wherein conducting the interview comprises capturing media content of an interview subject.

16. The method of claim 15 further comprising generating a plurality of demarcated media items, wherein each demarcated media item from the plurality of demarcated media items is associated with a particular question from the set of questions.

17. The method of claim 16, wherein each demarcated media item from the plurality of demarcated media items comprises a start time and an end time associated with the captured media content of the interview subject further comprising.

18. The method of claim 17 further comprising generating a transcript of the interview by analyzing the captured media content of the interview subject.

19. The method of claim 18 further comprising dividing the transcript into sections, wherein each section is associated with a different demarcated media item from the plurality of demarcated media items.

20. The method of claim 19, wherein the start time and the end time are determined based on user selections made while the interview is conducted.
